(19) United States
(12) Patent Application Publication
(10) Pub. No.: US 2011/0216930 A1
(43) Pub. Date: Sep. 8, 2011

(54) ELECTRONIC APPARATUS AND AUDIO CONTROL METHOD

(76) Inventor: Kaori Kobayashi, Kumagaya-shi (JP)

(21) Appl. No.: 12/968,143

(22) Filed: Dec. 14, 2010

(30) Foreign Application Priority Data
Mar. 8, 2010 (JP) JP 2010-051116

(51) Int. Cl. H04R 1/02; H04R 9/06

(52) U.S. Cl. 381/332

(57) ABSTRACT

An electronic apparatus including: a speaker configured to output sound; an equalizer configured to modify a characteristic of an audio signal input to the speaker; and a storage configured to store information indicating intensities for each signal component of a plurality of frequency bands of the audio signal, wherein the apparatus is capable to be installed in a first installment state, in which the apparatus is mounted on a wall, and wherein the storage is configured to store, as first standard values, information indicating the intensity of signal components for each frequency band to be used when the apparatus is installed in the first installment state.

### CROSS-REFERENCE TO THE RELATED APPLICATION(S)

The present application is based upon and claims priority from prior Japanese Patent Application No. 2010-051116, filed on Mar. 8, 2010, the entire contents of which are incorporated herein by reference.

### FIELD

Embodiments described herein relate to an electronic apparatus and audio control method.

### BACKGROUND

Sound that is output by speakers housed in a television set, is reflected by objects existing in the same room as the television set is placed, and by the walls of the room. The way in which the sound is heard is therefore altered by the positional relationships between the speakers outputting the sound, and objects that reflect the sound, such as a TV rack and walls.

Adjustment is sometimes made to the audio characteristics resulting from the placement position of a television set. An example of such technique is disclosed in JP-A-2008-035254. According to the technique disclosed in JP-A-2008-035254, the quality of sound of speakers housed in a television set can be adjusted according to the type of room (e.g., western style room, Japanese style room, bedroom) in which a television set 100 is placed, and according to the placement position in the room (e.g. against the wall, in the corner).

Speakers are generally configured from a magnet, a voice coil, and a paper cone. The coil is driven by magnetic field lines of the magnet, and movement of magnetic field lines due to an audio current, the paper cone is caused to vibrate by this driving, and sound is output due to the sound waves generated thereby. A certain thickness is required in the speaker construction along the sound output direction due to the magnet, voice coil, and paper cone being disposed in a row along the sound output direction.

There is a recent tendency towards having thinner casings for television sets, and the point has already been reached where the thickness of the television set is the same as, or less than, the thickness of the speakers.

Whereas television sets are usually placed on a TV rack or the like, supported by a stand, the possibility for wall mounting has arisen as television sets have become thinner. When television sets are mounted by hanging on a wall, there is great variation in the height of placement and in the objects placed below the speakers. Since the positional relationship between the speakers and objects present in the sound output direction changes, a great variation also occurs in the sound listened to from reflection by these objects. There is consequently demand for adjusting audio settings while a user is actually listening to the sound output from a television set after the television set has been mounted by hanging on a wall, in order to realize an improved audio experience.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is an external view of a stand mounted television set of the present exemplary embodiment.

FIG. 2 is an external view of a wall mounted television set of the present exemplary embodiment.

FIG. 3 is a functional block diagram of a television set of the present exemplary embodiment.

FIG. 4 is a functional block diagram relating to audio processing of the present exemplary embodiment.

FIG. 5 is a diagram showing a preset mode screen when stand mounted in the present exemplary embodiment.

FIG. 6 is a diagram showing a preset mode screen when wall mounted in the present exemplary embodiment.

FIG. 7 is a diagram showing an example of audio control on a preset mode screen of the present exemplary embodiment.

FIG. 8 is a flow chart of an audio control sequence in the present exemplary embodiment.

### DETAILED DESCRIPTION

According to the embodiments described herein, there is provided an electronic apparatus including: a speaker configured to output sound; an equalizer configured to modify a characteristic of an audio signal input to the speaker; and a storage configured to store information indicating intensities for each signal component of a plurality of frequency bands of the audio signal, wherein the apparatus is capable to be installed in a first installment state, in which the apparatus is mounted on a wall, and wherein the storage is configured to store, as first standard values, information indicating the intensity of signal components for each frequency band to be used when the apparatus is installed in the first installment state.

Embodiments according to the present invention will be described in detail with reference to the accompanying drawings. The scope of the claimed invention should not be limited to the examples illustrated in the drawings and those described in below.

Explanation follows regarding a television set 100, serving as an example of an electronic apparatus according to embodiments described herein. The television set 100 of the present exemplary embodiment has at least two installation states, stand mounting in which the television set 100 is placed on a TV rack 160 using a stand 120, and wall mounting in which the television set 100 is mounted by hanging on a wall, without the stand 120. Hanging on a wall refers to, for example, fixing onto a wall a fitting for hanging the television set 100, and mounting the television set 100 by hanging the television set 100 on the fitting.

The television set 100 also has two preset audio modes, corresponding to the two installation states. These preset audio modes are initial settings in each of the installation states, with the manufacturer measuring the frequency characteristics when wall mounted and when stand mounted, to obtain the differences between the installation states for respective components of plural frequency bands. The initial settings are those in which the signal intensities of each of the signal components have been adjusted to give appropriate sound for listening to in each of these installation states. When using the television set 100 for the first time, a user selects as the initial audio setting one or other of the stand mounted preset mode or the wall mounted preset mode.

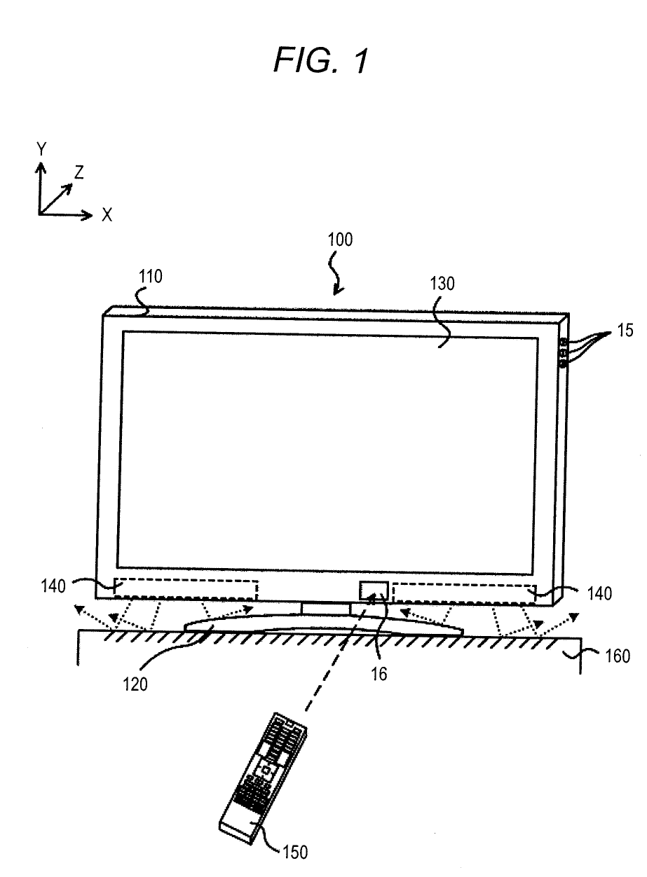

Explanation will first be given regarding stand mounting as a first installation state of the television set 100, with reference to FIG. 1. FIG. 1 shows the external appearance of the television set 100 in the present exemplary embodiment, stand mounted. In the present exemplary embodiment, XYZ axes are defined as shown at the top left of FIG. 1, with the X axis indicating the left-right direction (with positive direction towards the right), the Y axis indicating the vertical direction (with positive direction upwards), and the Z axis indicating into and out of the page (with positive direction into the page). The display surface of a display 130 is disposed in the XY plane.

The television set 100 is mainly configured from a flat cabinet 110 and the stand 120 that supports the cabinet 110. The cabinet 110 houses electronic devices such as a tuner 3, described later. The stand 120 is a support mechanism for placing the television set 100 on the TV rack 160. The display 130 is disposed at a central portion on the front face of the cabinet 110, enabling picture viewing. Speakers 140 are disposed at the left and right hand sides of the bottom edge of the cabinet 110, enabling stereo audio reproduction.

The speakers 140 are installed in the cabinet 110 such that the sound output direction faces downwards, with sound being output towards the bottom of the television set 100. The output sound is reflected from the TV rack 160, on which the television set 100 is placed, from the stand 120 positioned below the speakers 140, and the like, enabling expansive sound to be listened to. Since the speakers 140 are disposed so as to output sound downwards, configuration is made such that the position where the speakers 140 are disposed is not visible from the front.

A user selects the stand mounted preset mode as the initial audio setting when the television set 100 is stand mounted as shown in FIG. 1. In the present exemplary embodiment, the audio settings can be further changed from the stand mounted preset mode, enabling sound to be tailored to the tastes of a user. Namely, the signal intensity can be changed from the standard signal intensity set in the stand mounted preset mode for each respective signal component of plural frequency bands. A detailed explanation regarding detailed audio settings is given later.

The display 130 is, for example, a Surface-conduction Electron-emitter Display (SED) panel or a Liquid Crystal Display (LCD) panel.

A receiver 16 is provided at a lower portion of the front face of the cabinet 110, for receiving commands by wireless transmission from a remote controller 150. An user interface 15, with the power switch and the like, is disposed on a side face of the cabinet 110 of the television set 100. The television set 100 receives an external power feed through a plug, not shown in the figures, receives various broadcasts through an antenna 1, described later, and outputs a video signal and an audio signal by decoding the signal of received broadcasts using a signal processor 5. The display 130 processes the decoded video signal and displays a picture, and the speakers 140 process the decoded audio signal and output sound.

In the present exemplary embodiment, electronic devices such as the tuner 3, are housed in the cabinet 110, however there is no limitation thereto. Namely, electronic devices such as the tuner 3 may be housed in a separated casing from that of the cabinet 110, such a casing connected to the television set 100, and the picture and sound output using the display 130 and the speakers 140 provided in the television set 100.

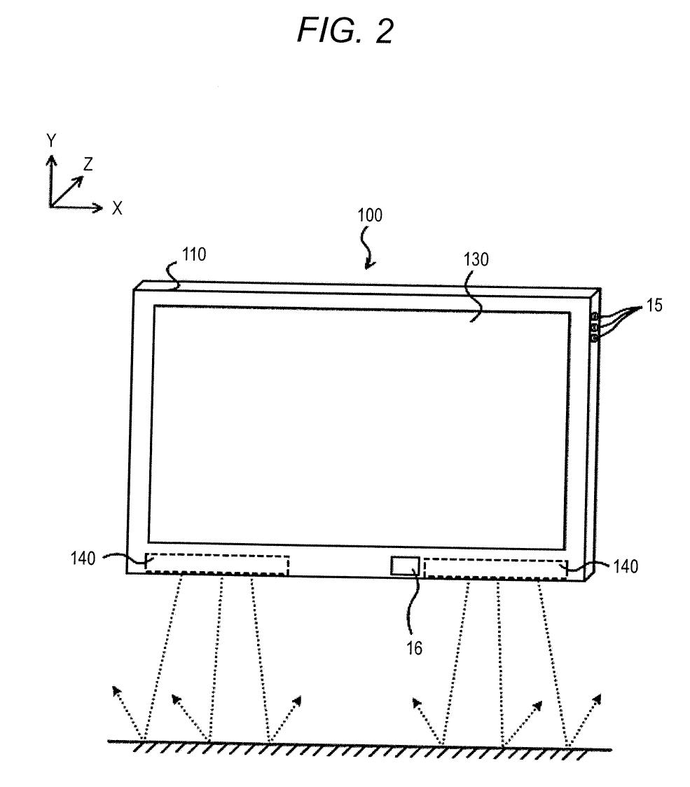

Explanation follows regarding wall mounting as a second installation state of the television set 100, with reference to FIG. 2. FIG. 2 shows the external appearance of the wall mounted television set 100 in the present exemplary embodiment.

As shown in FIG. 2, the cabinet 110 is not mounted on the TV rack 160 using the stand 120, but is, instead, hung on a fixing (not shown in the figures) that has been fixed to a wall. Consequently, sound output from the speakers 140 is reflected by objects placed below.

When wall mounted, objects placed below the speakers 140 are not fixed, as in the TV rack 160 when stand mounted. Namely, there may be a large difference between the distance from the cabinet 110 to the floor compared with from the cabinet 110 to the TV rack 160, depending on user placement choice. Accompanying changes are exhibited in the way in which sound from the speakers 140 is reflected.

A user selects the wall mounted preset mode as the initial audio setting when the television set 100 has been wall mounted as shown in FIG. 2. However, with wall mounting, since there are many placement options depending on user choice, a placement may result that is different to the manufacture's anticipated placement state. Consequently, the sound set by the manufacture in the preset mode is not always an appropriate audio setting. In order to address this issue, in the present exemplary embodiment, the audio settings can be further changed from the wall mounted preset mode. In other words, taking each of the signal intensities for the respective signal component of the plural frequency bands set in the wall mounted preset mode acting as a standard, the respective signal intensity can be changed therefrom. Details regarding these detailed audio settings are set out below.

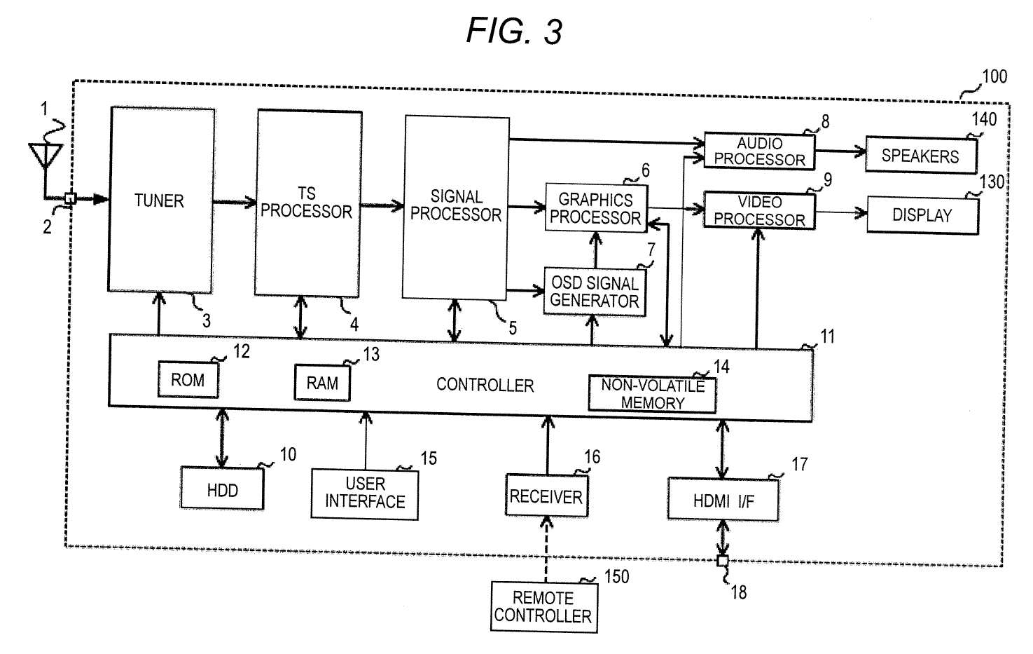

Explanation follows regarding the television set 100 configuration, with reference to FIG. 3. FIG. 3 is a functional block diagram of the television set 100 of the present exemplary embodiment.

The television set 100 includes: the antenna 1; an input terminal 2; the tuner 3; a Transport Stream (TS) processor 4; a signal processor 5; a graphics processor 6; an On Screen Display (OSD) signal generator 7; an audio processor 8; a video processor 9; a Hard Disk Drive (HDD) 10; a controller 11; the user interface 15; a receiver 16; an HDMI I/F 17; an HDMI terminal 18; the display 130; and the speakers 140.

The controller 11 includes: Read Only Memory (ROM) 12, Random Access Memory (RAM) 13; non-volatile memory 14; and a Central Processor Unit (CPU).

The antenna 1 is an antenna configured to enable receiving of broadcasting standards such as terrestrial digital broadcasts, BS digital broadcasts and CS digital broadcasts.

The input terminal 2 inputs the broadcast signal received from the antenna 1 into the tuner 3.

Under control of a control signal from the controller 11, the tuner 3 selects the broadcast signal of the desired channel, out of the three types of terrestrial digital broadcasts, BS digital broadcasts and CS digital broadcasts. The tuner 3 then demodulates the selected broadcast signal (performs Orthogonal Frequency Division Multiplexing (OFDM) demodulation for terrestrial digital broadcasts, Phase Shift Keying (PSK) demodulation for BS digital and CS digital broadcasts) to obtain a Transport Stream (TS) containing the desired program, which is then input to the TS processor 4.

The tuner 3 selects the TS of the specified channel from the input broadcast signals, and inputs the TS to the TS processor 4.

The TS processor 4 is input with the TS of the specified channel from the tuner 3, re-multiplexes a plural number of TSs into a single TS, and outputs to the signal processor 5. The signal processor 5 performs appropriate digital signal processing on the TS of the multiplexed plural channels output from the TS processor 4. The TS subjected to digital signal processing is separated into a data signal, a video signal, and an audio signal. The separated signals are then each respectively output, the video signal to the graphics processor 6, the audio signal to the audio processor 8, and the data signal to the OSD signal generator 7 and/or the controller 11. In order to record a broadcast, the TS re-multiplexed by the TS processor 4 is output to the controller 11.

The data signal contains various data relating to the broadcast program, for example, EPG data. Such EPG data includes data such as channel information, channel number, channel name and schedule.

The graphics processor 6 performs decoding on the digital video signal output from the signal processor 5. The decoded video signal is synthesized by superimposing on an OSD signal output from the OSD signal generator 7, and is then output to the video processor 9. The graphics processor 6 may also selectively output the decoded video signal or the OSD signal to the video processor 9.

Under control from the controller 11, the OSD signal generator 7 generates an OSD signal for display, such as on a User Interface (UI) screen. The data signal, separated from the digital broadcast signal in the signal processor 5, is converted into an OSD signal of appropriate format by the OSD signal generator 7, and output to the graphics processor 6.

The audio processor 8 performs audio processing on the audio signal input from the signal processor 5, using plural audio parameters stored in an equalizer 35, described later, converting the audio signal into an analogue signal of a format reproducible by the speakers 140. The audio signal converted to analogue is output and reproduced by the speakers 140.

The video processor 9 converts the signal output from the graphics processor 6 into an analogue video signal of a format displayable on the display 130. This video signal converted to analogue is output to the display 130.

The HDD 10 stores the TSs by channel, based on control from the controller 11. The controller 11 runs a system control program and various processing programs, stored in advance on the ROM 12, according to commands input from the user interface 15, and commands transmitted from the remote controller 150 and received via the receiver 16. According to the invoked program, the controller 11 controls the operation of the RAM 13 as working memory for each device component.

The controller 11 controls functions of the television set 100 for recording, and playing back recorded programs. The controller 11 restores the plural channel multiplexed TS output from the TS processor 4 to a separate TS for each channel, and stores these on the HDD 10.

The controller 11 executes control for reproducing the recorded data, and after the TS stored by channel on the HDD 10 has been read out and reproduced, the controller 11 can use the TS for display on the display 130, for outputting sound from the speakers 140, or the like.

The ROM 12 is memory for storing a system control program and various processing programs executed by the CPU.

The RAM 13 is “working memory”, for use by the CPU to expand various programs.

The non-volatile memory 14 stores data required for operational control of each component, such as various setting data and control data.

The user interface 15 receives commands according to operation of the user interface 15 by a user, and inputs the commands to the controller 11.

The receiver 16 receives commands according to operation of the remote controller 150 by a user, and inputs the commands to the controller 11.

The HDMI terminal 18 is connected to the controller 11 through the HDMI I/F 17. A PC, liquid crystal display, or AV amp, for example, is connected to the HDMI terminal 18. The controller 11 can convey data to and from devices connected through the HDMI terminal 18 and the HDMI I/F 17.

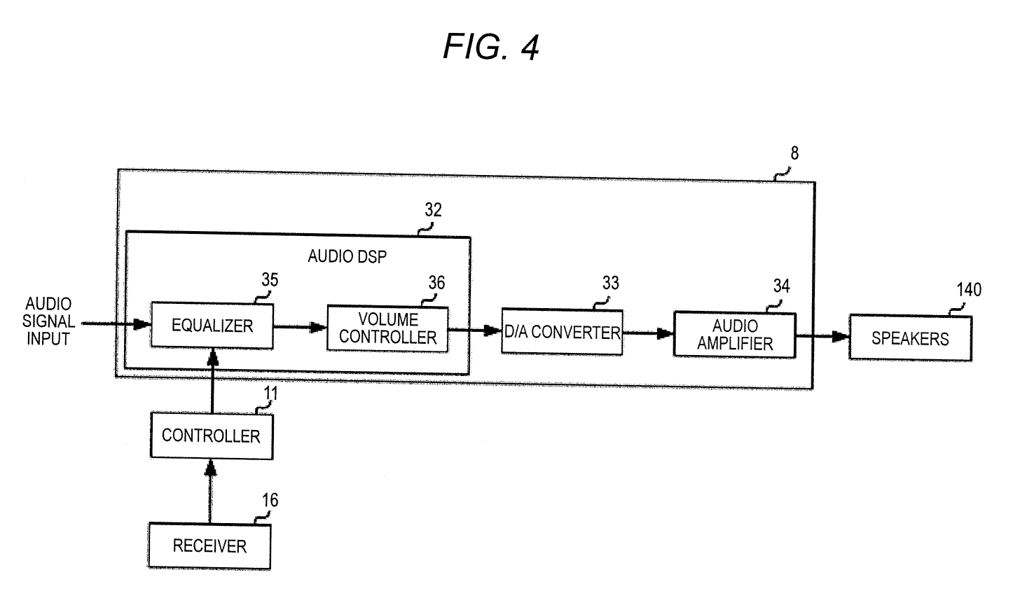

Explanation follows regarding operation of audio processing in the present exemplary embodiment, with reference to FIG. 4. FIG. 4 is a functional block diagram relating to audio processing in the present exemplary embodiment.

The audio processor 8 includes an audio Digital Single Processor (DSP) 32, a D/A converter 33, and an audio amplifier 34. The audio DSP 32 is a microprocessor for performing audio processing, and includes functional components of an equalizer 35, and a volume controller 36.

The equalizer 35 changes the intensity (gain level) of five frequency bands (100 Hz/330 Hz/1 kHz/3.3 kHz/10 kHz) of the audio signal, according to commands input through the controller 11 and received by the receiver 16. By emphasizing or deemphasizing particular frequency bands of the audio signal, the equalizer 35 can correct the overall sound quality. The equalizer 35 stores standard values of gain level for each of the frequency bands in the stand mounted and the wall mounted preset modes.

The volume controller 36 sets the sound level actually required for output from the gain levels of the audio signal that have been adjusted by the equalizer 35, and outputs to the D/A converter 33.

The D/A converter 33 converts the digital audio signal adjusted by the audio DSP 32 into an analogue audio signal and outputs to the audio amplifier 34.

The audio amplifier 34 amplifies the analogue signal input from the D/A converter 33 by a specific amplification rate, and outputs to the speakers 140.

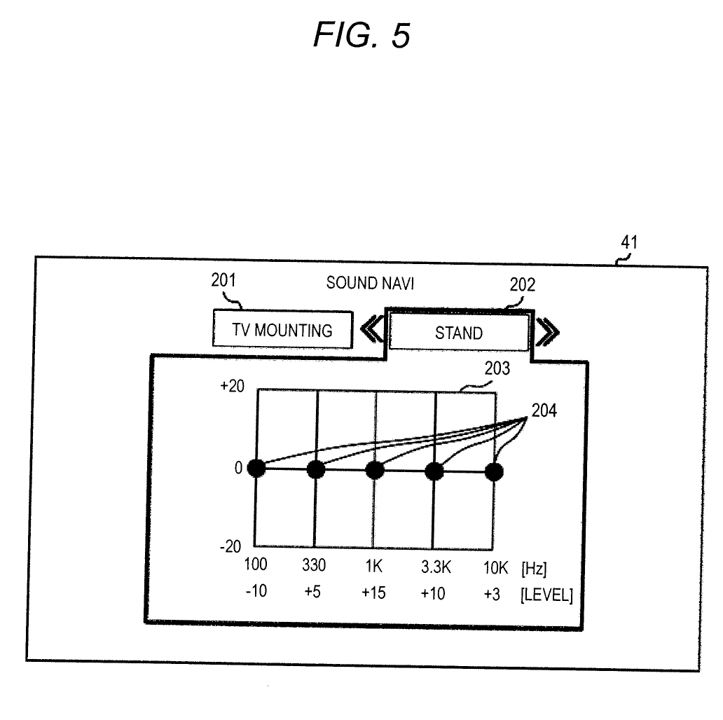

Explanation follows regarding audio control executed with an audio control screen 200, with reference to FIGS. 5 to 7. FIG. 5 is a diagram showing a stand mounted preset mode screen in the present exemplary embodiment.

The audio control screen 200 displays a wall mounted tab 201, a stand mounted tab 202, an audio control graph 203, and pointers 204.

The wall mounted tab 201 is a tab for selecting preset mode when wall mounted. The wall mounted tab 201 is, for example, indicated by “TV Mounting”.

The stand mounted tab 202 is a tab for selecting preset mode when stand mounted. The stand mounted tab 202 is, for example, indicated by “Stand”.

The wall mounted tab 201 and the stand mounted tab 202 are selectable by operation of the remote controller 150.

The audio control graph 203 is a graph with each of the frequency bands shown on the horizontal axis and gain level on the vertical axis.

The pointers 204 are pointers that indicate on the audio control graph 203 the gain levels for the respective frequency bands. For each of the frequency bands, the gain levels as modified by commands input from the remote controller 150 are shown.

In the present exemplary embodiment, central frequencies of the frequency bands are positioned at 100 Hz, 330 Hz, 1 kHz, 3.3 kHz and 10 kHz. The gain levels are values indicating the intensity of audio signal for each of the respective frequency bands. The gain levels are set as specific sound intensities (in dB units) for each level, with the standard values of each of the preset modes set as 0.

The standard values in the preset modes for each of the installment states are set to gain levels determined at the time of manufacture to be appropriate for listening under specific conditions. The stand mounted preset mode and the wall mounted preset mode have different standard values of gain level (values for 0) for each of the frequency bands. Use of these initial settings for gain levels, corresponding to each of the installment states, alleviates the need for large audio adjustments, and a higher level of ease-of-use can be achieved.

In the present exemplary embodiment, explanation is given of an example in which the central frequencies and band widths (Q values) of the equalizer 35 are fixed in a graphic equalizer, however configuration may be made with a parametric equalizer in which the central frequencies and band widths are variable.

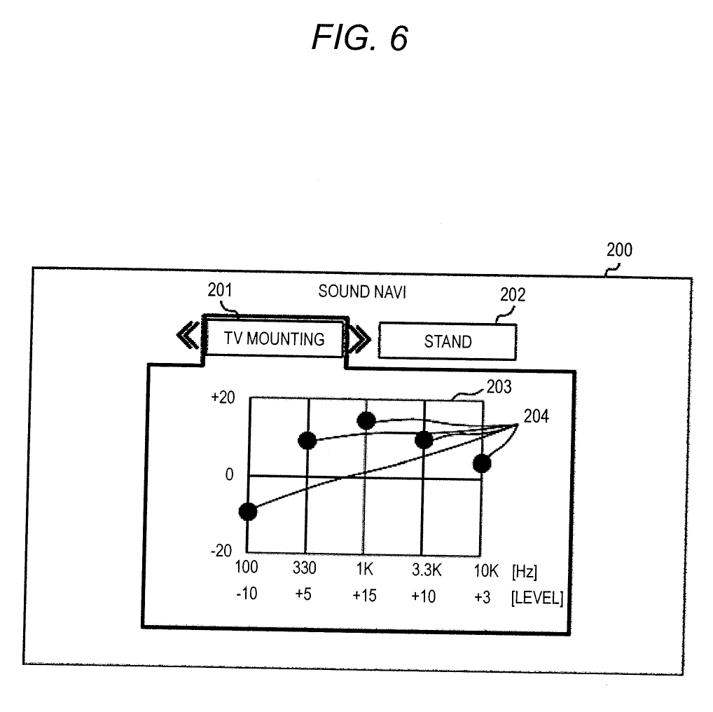

FIG. 6 is a diagram showing a preset mode screen when wall mounted in the present exemplary embodiment. The wall mounted preset mode screen is displayed when the wall mounted tab 201 is selected. When the wall mounted tab 201 is selected, the standard values stored in the equalizer 35 for the wall mounted preset mode are read out, and the gain levels are displayed with signal components of each of the frequency bands in the stand mounted preset mode as standard (zero).

FIG. 6 is an example of the wall mounted preset mode, with initial settings such that the audio signal at 100 Hz is reduced by 10 levels from the standard value of the stand mounted preset mode, the audio signal at 330 Hz is 5 levels higher than the corresponding standard value, the audio signal at 1 kHz is 15 levels higher than the corresponding standard value, the audio signal at 3.3 kHz is 10 levels higher than the corresponding standard value, and the audio signal at 10 kHz is 3 levels higher than the corresponding standard value. Generally, in the wall mounted preset mode, the low frequency components are generally set with minus values due to low frequency audio signal components tending to increase in intensity with proximity to a wall.

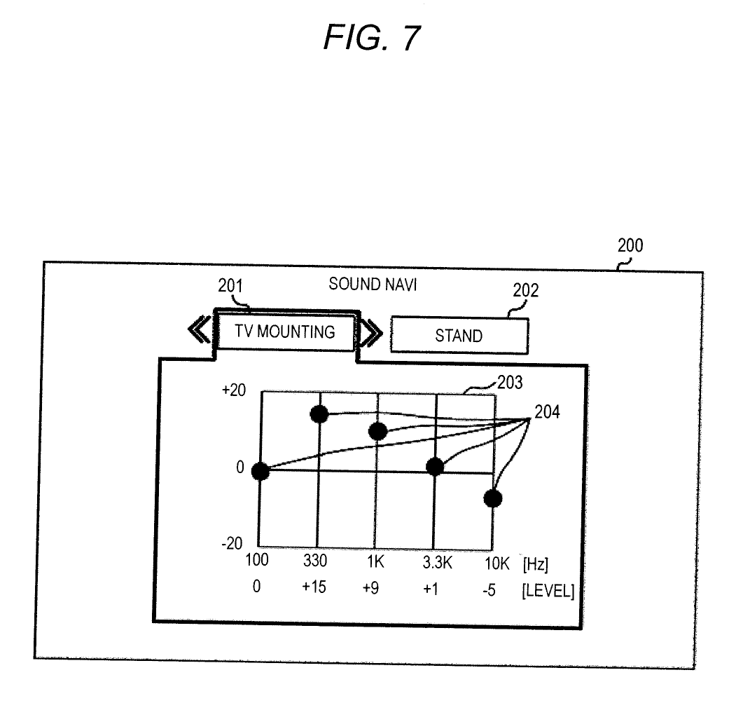

FIG. 7 shows an example of audio control by the audio control screen 200 in the present exemplary embodiment. For example, explanation follows of an example in which wall mounting is selected as the installment state. The gain level can be increased or decreased for each of the signal components of the frequency bands by operating the remote controller 150. In the example of FIG. 7, changes have been made such that the audio signal at 100 Hz is the same value as the standard value of the stand mounted preset mode, the audio signal at 330 Hz is 15 levels higher than the corresponding standard value, the audio signal at 1 kHz is 9 levels higher than the corresponding standard value, the audio signal at 3.3 kHz is 1 level higher than the corresponding standard value, and the audio signal at 10 kHz is 5 levels lower than the corresponding standard value.

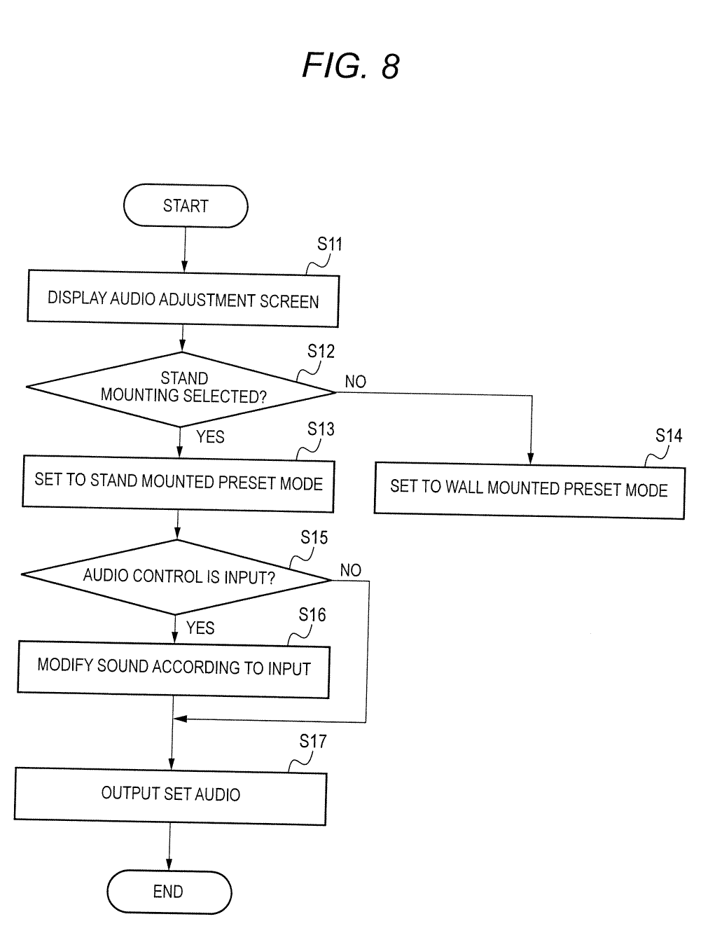

Explanation follows of a sequence of audio control processing in the present exemplary embodiment, with reference to FIG. 8. FIG. 8 is a flow chart of an audio control sequence in the present exemplary embodiment.

The equalizer 35 displays the audio control screen 200 according to commands input from the remote controller 150 (step S11).

Next, the controller 11 determines whether or not stand mounting has been selected from the commands input from the receiver 16 (step S12). Namely, determination is made as to whether or not the stand mounted tab 202 is selected. When the determination result of Step S12 is determination that stand mounting has been selected (Step S12=Yes), the standard values for the stand mounted preset mode are read in (Step S13).

However, if the determination result of Step S12 is determination that wall mounting has been selected (Step S12=No), the standard values for the wall mounted preset mode are read in (Step S14).

Next, determination is made as to whether or not input relating to audio control has been input to the equalizer 35 (Step S15). Namely, determination is made as to whether or not a command to increase or decrease the gain level of any of the frequency bands has be input from the remote controller 150.

When the determination result at Step S15 is determination that audio control input has been made (Step S15=Yes), audio is modified according to the input (Step S16). Namely, the gain level for the audio signal of the selected frequency band is increased or decreased. The equalizer 35 outputs an audio signal of the modified audio characteristics to the volume controller 36 (step S17).

When the determination result at Step S15 is that no input relating to audio control has been made (Step S15=No), the sequence proceeds to Step S17. The audio control sequence of the present exemplary embodiment is ended after the above.

According to the configuration of the present exemplary embodiment as described above, the sound can be modified to sound appropriate to the preferences of a user both when the television set 100 is placed so as to be supported by the stand 120, and also when the television set 100 placed hung on a wall.

When the speakers 140 are housed in the television set 100 such that sound is output downwards, sound is reflected by objects present in the direction of sound output. A user therefore listens to sound reflected from the TV rack 160 disposed below the television set 100, or the floor. In particular, when wall mounted, since the mounting height, objects present below the speakers, and the like, are determined by the user, a large change may be exhibited in the way sound is reflected.

According to the present exemplary embodiment, after mounting the television set 100 and selecting audio for either the wall mounted preset mode or the stand mounted preset mode, a user can then make further detailed changes to the audio settings so give suitable sound for listening. Such sound suitable for listening is, in other words, sound according to the taste of the user, and settings can be changed in the audio, to emphasize low frequency sound, deemphasize low frequency sound, emphasize high frequency sound, and deemphasize high frequency sound.

In the present exemplary embodiment, explanation has been given of an example in which the speakers 140 placed so as to output sound downwards, however there is no limitation thereto. Configuration may be made in which sound output from the speakers 140 is not directly heard by a user positioned in front of the display 130 (in the Z axis minus direction), and the speakers 140 are set such that sound is reflected from objects. For example, the speakers 140 may be mounted so as to output sound in a direction along the display surface of the display 130 (the XY plane). In such cases, the output sound is reflected by walls or the like positioned above, to the left, and/or to the right. Accordingly, by performing the audio control of the present exemplary embodiment, and modifying to achieve sound appropriate for listening to, the sound quality of the television set 100 can be raised.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a speaker configured to output sound;
an equalizer configured to modify a characteristic of an audio signal input to the speaker; and
a storage configured to store information indicating intensities for each signal component of a plurality of frequency bands of the audio signal,
wherein the apparatus is capable to be installed in a first installment state, in which the apparatus is mounted on a wall, and
wherein the storage is configured to store, as first standard values, information indicating the intensity of signal components for each frequency band to be used when the apparatus is installed in the first installment state.

2. The apparatus of claim 1,
wherein the speaker is configured to output sound downwards.

3. The apparatus of claim 1,
wherein the apparatus is capable to be installed in a second installment state, in which the apparatus is supported upright with a stand, and
wherein the storage is configured to store, as second standard values, information indicating the intensity of signal components for each frequency band to be used when the apparatus is installed in the second installment state.

4. An audio control method for an electronic apparatus comprising a speaker configured to output sound, the method comprising:
selecting a installment state from a plurality of installment states comprising a first installment state, in which the apparatus is mounted on a wall;
storing information indicating intensities for each signal component of a plurality of frequency bands of the audio signal, as a plurality of standard values to be used for each of the installment states;
reading out one of the standard values that corresponds to the selected installment state; and
modifying the intensity for each of the signal components of each respective frequency band based on the read-out standard value.

5. An electronic apparatus comprising:
a storage configured to store a first audio parameter to be used when the apparatus is installed in a first installment state, in which the apparatus is mounted on a wall, and a second audio parameter to be used when the apparatus is installed in a second installment state, in which the apparatus is supported upright with a stand;
an audio processor configured to execute audio processing comprising a first audio processing using the first audio parameter and a second audio processing using the second audio parameter; and
a user interface configured to allow a user to select the first audio processing or the second audio processing.
